(19) United States
(12) Patent Application Publication
(10) Pub. No.: US 2016/0299928 A1
(43) Pub. Date: Oct. 13, 2016

(54) VARIABLE RECORD SIZE WITHIN A HIERARCHICALLY ORGANIZED DATA STRUCTURE

(71) Applicant: INFOTRAX SYSTEMS, OREM, UT (US)

(72) Inventors: Larry Nash, Provo, UT (US); Dan Floyd, West Jordan, UT (US); Jake Stowell, Orem, UT (US); Mark Rawlins, Lehi, UT (US)

(21) Appl. No.: 14/683,757

(22) Filed: Apr. 10, 2015

(51) Int. Cl. G06F 17/30

(52) U.S. Cl. CPC G06F 17/30327; G06F 17/30091; G06F 17/30864

(57) ABSTRACT

A computerized method for efficiently storing data entries within a database can comprise identifying a particular number of records within a hierarchical tree, which records can comprise fields. The method can also comprise writing to storage at least a portion of the fields of the hierarchical tree in a flat file order that is directly related to the order of records in the hierarchical tree. Writing to storage at least a portion of the fields of the hierarchical tree can comprise disregarding a plurality of fields that contains a particular value so that the disregarded plurality of fields do not exist in storage. Additionally, the method can comprise reading the tree so that when encountering a field not found in storage the field is designated for that record as containing the particular value.

### BACKGROUND OF THE INVENTION

1. Technical Field

The present invention relates generally to computer-based database systems.

2. Background and Relevant Art

Many businesses store hierarchically organized data in databases where any entry (or row) may be the parent of one or more child entries (or rows) within the database. A typical hierarchically organized database stores data in a relational database table. Although standard relational database access techniques can be used to access and process hierarchical data stored in this manner, these techniques can be slow especially when the hierarchical structure is large.

These slower techniques that have been used for accessing and processing hierarchical data have limited the number and type of real-time applications that consume the hierarchical data. In one example, multi-level marketing companies maintain hierarchical data structures representing the hierarchy of individuals participating in the multi-level marketing (“MLM”) business.

A typical hierarchical database will store many different pieces of data for each individual such as the total amount of sales for the individual in a specified period, a number of new customers obtained in a specified period, etc. One common computation performed on the hierarchical data is the calculation of commissions based on the total amount of sales for each individual. One individual's commission is generally based not only on the individual's sales, but the sales of other individuals under the individual in the hierarchy. In a large hierarchy, it may take a relatively long time to calculate the commission, or to calculate another figure that is dependent on the hierarchical relationships, for an individual. Additionally, in some cases, sales data may be stored within multiple independent hierarchies, requiring that data gathering and calculations be performed on multiple hierarchies, and requiring multiple requests directed towards each individual hierarchy.

For at least these and other reasons, many functions cannot be provided in real-time. Specifically, conventional databases make it difficult or impossible to provide or display certain real-time information such as commissions for individuals in a multi-level marketing organization, in particular, when data is split between multiple independent hierarchies. Accordingly, there are a number of disadvantages with organizational databases that can be addressed.

### BRIEF SUMMARY OF THE INVENTION

The present invention extends to systems, methods, and computer program products for efficiently storing an ordered flat file within memory. In particular, implementations of the present invention can include mechanisms that disregard fields that contain specific values. When the system queries a disregarded field, implementations of the present invention can be configured to return a default value. Alternative or additional implementations of the present invention include systems that can disregard data fields that comprise information that is calculated from data stored in other data fields.

For example, at least one implementation of the present invention comprises a computerized method for efficiently storing data entries within a database. The method can comprise identifying a particular number of records within a hierarchical tree. In one implementation, each record within the hierarchical tree can comprise a specific number of fields. Additionally, the method can comprise identifying a particular value within fields of the hierarchical tree that appears within a plurality of the fields of the hierarchical tree.

The method can also comprise writing to storage at least a portion of the fields of the hierarchical tree in a flat file order that is directly related to the order of records in the hierarchical tree. Writing to storage at least a portion of the fields of the hierarchical tree can comprise disregarding a plurality of fields that contains the particular value so that the disregarded plurality of fields do not exist in storage. Additionally, the method can comprise reading the tree so that when encountering a field not found in storage the field is designated for that record as containing the particular value.

An additional or alternative implementation of the present invention of a computerized method for efficiently storing data entries within a database can comprise receiving an inquiry directed towards a particular field within a record associated with a node of a hierarchical tree. Additionally, the method can comprise directing the inquiry to a flat file that represents the hierarchical tree. The method can also comprise accessing the record within the flat file. Further, the method can comprise determining that the requested field does not exist within the record. Further still, the method can comprise upon identifying that the requested field does not exist, returning a value that indicates an actual value for the field.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof, which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary computer environment in which the present invention may be implemented;

FIG. 2 illustrates exemplary hierarchically organized data and an exemplary ordered flat file derived from the data;

FIG. 3A illustrates a query being applied to multiple hierarchical tree structures;

FIG. 3B illustrates memory blocks storing an ordered flat file;

FIG. 4 is a flowchart of an exemplary method implemented by one or more embodiments of the invention; and

FIG. 5 is a flowchart of another exemplary method implemented by one or more embodiments of the invention.

### DETAILED DESCRIPTION OF THE PREFERRED EMBODIMENTS

The present invention extends to systems, methods, and computer program products for efficiently storing an ordered flat file within memory. In particular, implementations of the present invention can include mechanisms that disregard fields that contain specific values. When the system queries a disregarded field, implementations of the present invention can be configured to return a default value. Alternative or additional implementations of the present invention include systems that can disregard data fields that comprise information that is calculated from data stored in other data fields.

Accordingly, one or more implementations of the present invention provide a system that stores hierarchical data within a flat file in a highly efficient format. In implementations where data within a hierarchical tree must be quickly accessible, the inventive system can provide significant benefits, particularly if all or most of the data can be loaded into high-speed memory. In some cases, a significant portion of a hierarchical tree may contain data fields that are set to zero, or some other frequently recurring value. In additional or alternative implementations, they system does not store those data fields. Instead, in that particular case, when those data fields are identified as not being present, the system can be configured to infer that the field is equal to zero, or some other designated value. As such, significantly larger hierarchical tree can fit within high-speed memory of a given size.

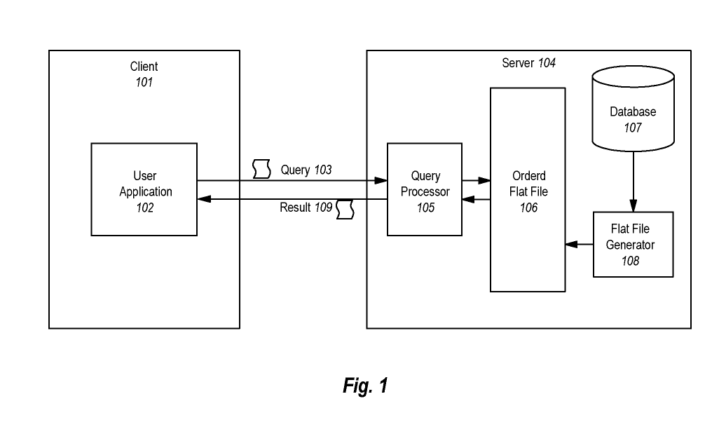

For example, FIG. 1 illustrates a generalized computer environment including a client 101 and a server 104 according to embodiments of the present invention. Client 101 may be any computer including a desktop, laptop, smart phone, etc. In at least one implementation, user application 102 on client 101 can comprise an application that sends queries to a remote computing device over a network, such as a server 104, which is configured for viewing hierarchical data stored in database 107. For example, user application 102 may be a general-purpose web browser, or may be a dedicated local or web-based application, which sends queries to a remote web server (e.g., server 104).

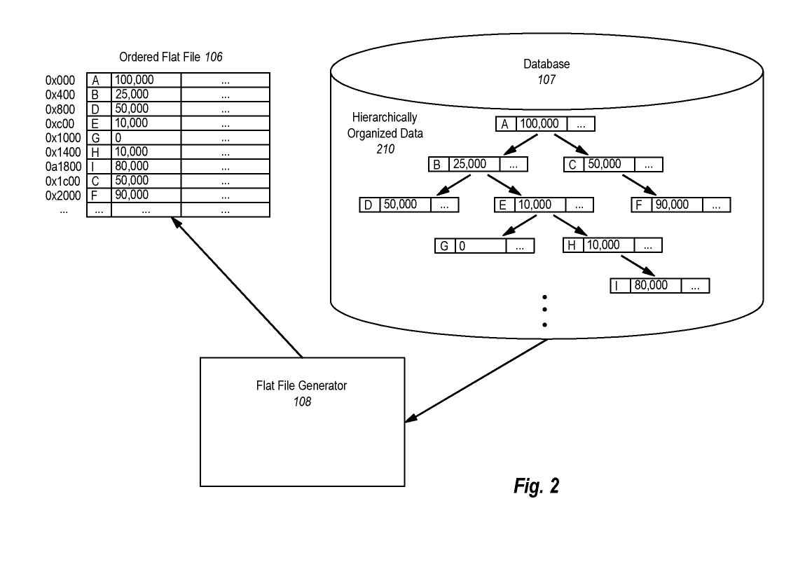

To expedite the processing of such queries, at least one implementation of the present invention can involve use of a flat file generator 108 on server 104 to create and maintain an ordered flat file 106. In at least one implementation, the ordered flat file 106 stores at least some of the hierarchical data of the database 107 as a flat file that maintains the hierarchical organization of the data, such as will be further described below with reference to FIG. 2. When the server 104 receives a query from a user application 102, the query processor 105 on server 104 accesses the data fields and entries within the ordered flat file 106 to resolve the query rather than accessing the underlying data in database 107. In some implementations, after initially creating the flat file 106, the server 104 can delete the hierarchical data in the database 107.

FIG. 2 depicts a database 107, which stores exemplary hierarchically organized data 210. In particular, FIG. 2 shows that the hierarchically organized data comprises a plurality of elements that each has at least one parent child relationship with another element. FIG. 2 also illustrates an exemplary ordered flat file 106 created from the hierarchically organized data 210 by flat file generator 108. In particular, FIG. 2 shows hierarchically organized data 210 as a tree structure for ease of illustration; however, one will appreciate that an ordered flat file can be created from an underlying database of any type or format (e.g., relational, flat file, etc.). The flat file generator 108 structures the ordered flat file 106 such that all direct descendants of an element are listed directly below the element within the flat file.

For example, because element A is the base node and all other elements are descendants of element A, the flat file generator 108 lists element A first in the ordered flat file. Next, the flat file generator 108 lists element B with all its direct descendants listed directly below it and prior to any other element that is at the same level or a higher level in the hierarchy than element B. For example, FIG. 2 shows an implementation in which flat file generator 108 lists element C (which is at the same level as element B (i.e., a brother of element B)) after all of element B's direct descendants (elements D, E, G, H, and I).

FIG. 2 further depicts an implementation in which the various elements (A, B, D, E, . . . ) are directly adjacent to each other in memory. In at least one implementation, however, the elements are not necessarily next to each other in memory. Instead, in additional or alternative implementations, the various elements can be linked in the same order depicted in the ordered flat file 106 using pointers. For example, Element B can include a pointer to the memory location of element D and element A. Accordingly, Element B could identify that Element A is directly above it in the ordered flat file 106 and that Element D is directly below it.

In this way, any element's descendants can be quickly determined by reading the ordered flat file 106 until an element with the same or higher level in the hierarchy is reached. For example, the query processor 105 can quickly determine that element I does not have any descendants because the next element below element I in the ordered flat file 106 is element C, which is a brother to element B, and is three levels higher than element I in the hierarchy.

In at least one implementation, each element within the ordered flat file can comprise a field that indicates the element's hierarchical parent. For example, element C can comprise a field that indicates that element A is element C's parent. As such, when traversing the ordered flat file from element I to element C, it can be determined that element C is not a child of element I, because C comprises an indication its parent is element A.

The listed fields in the ordered flat file 106 of FIG. 2 represent the element's name (or identifier) and a total sales amount for the person represented by the element. However, an ordered flat file can include any number of fields storing any type of data as indicated by the ellipses For example, FIG. 2 illustrates an implementation in which each element in the ordered flat file 106 includes a field that defines the element's level in the hierarchy, or that may indicate a person's (represented by the element) title, rank, or position in a company structure, as well as other fields containing data that may be used to calculate reports. The ordered flat file 106 of FIG. 2 depicts elements that are 1 KB in size as represented by the hexadecimal addresses to the left of each element. However, any size may be allocated to elements in the hierarchy, and each element may in fact be a different size. One will appreciate that, in at least one embodiment, each element is the same size.

One will appreciate in view of the specification and claims herein that an ordered flat file can be particularly beneficial in representing a “downline” of an individual in a hierarchical organization, such as a multi-level marketing business structure. An individual's “downline” in a multi-level marketing hierarchy refers to the individual and all other individuals that fall below the individual in the hierarchy. Using the example of FIG. 1, element B's downline would include elements D, E, G, H, and I (but not C, F). Thus, a system can quickly determine B's downline by sequentially reading the ordered flat file from element B to element I and stopping before elements C and F.

Generally, it is faster to access hierarchical data stored in an ordered flat file than it is to access the same data stored in an underlying database. Therefore, calculations based on hierarchical data, such as commissions as previously described, can be performed more quickly by creating an ordered flat file of the hierarchical data, and accessing the hierarchical data within the ordered flat file to generate the required result set.

The flat file generator 108 may create an ordered flat file from a hierarchical dataset stored in an underlying database at various times. For example, a multi-level marketing business may update its database with sales figures at the end of each business day. After the updates are entered each day, a complete ordered flat file may be generated to represent the state of the hierarchical data after the updates for that day are entered. Of course, an ordered flat file may be created at any interval. Additionally, in at least one embodiment, an existing flat file can be updated to reflect new information by individually accessing and updating each required data field. For example, a new element could be added to an ordered flat file 106 by updating one or more pointers to include the new element at the correct location within the file.

Generally, a query for data of a hierarchical dataset causes the server to request a sub-portion of the hierarchical dataset. One example includes a query for an individual's downline. As described above, the sub-portion of hierarchical data can be obtained by reading a sequential portion of the ordered flat. To locate the beginning of the sequential portion to be read, an initial or starting, element must be identified. For example, to locate the beginning of element B's downline, the query processor 105 will need to identify element B in the ordered flat file.

At least two approaches can be taken to locate the beginning of the sequential portion: “sequential access,” and “random access.” Sequential access refers to reading from the beginning of the ordered flat file, and continuing to read the elements in the ordered flat file until the first element of the sequential portion is identified. Once the first element is identified, any permissions (i.e., filtering conditions) in the query can be applied to the elements in the portion as the elements are read.

Random access, on the other hand, refers to reading an element of the ordered flat file without first reading the preceding elements in the ordered flat file. Random access can be accomplished by maintaining a location index for each element in the ordered flat file. Reading the element's location within the index and then accessing the ordered flat file at the address provided by the index can determine an element's location in the ordered flat file. In at least one implementation, the index and/or the flat file can be addressed using a hash map.

In either sequential or random access, once the first element of the sequential portion is identified, the remaining elements of the sequential portion can quickly be retrieved by sequentially reading the ordered flat file until an element that is at the same or higher level in the hierarchy is identified at which point no further reads need to be performed. As each element in the sequential portion is read, the filtering condition can be applied to generate one or more result sets. In other words, the query processor 105 need only perform a single pass of the ordered flat file to identify the relevant portion and to apply the permissions to the portion to generate one or more result sets.

As described above, implementations of the present invention provide methods and systems for quickly accessing data elements from within hierarchical tree structures. In addition to the ability to quickly access the data element, in at least one implementation, various permissions or filters can be applied to the query results. In particular, one or more administrators can create rules that determine what information a given user can access and retrieve from within the database.

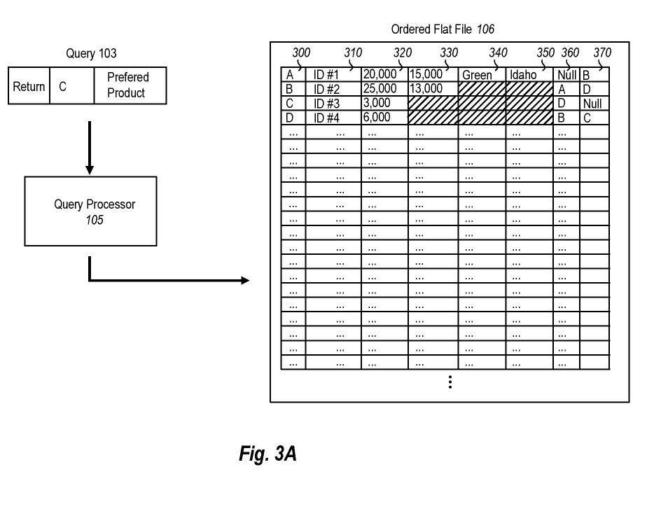

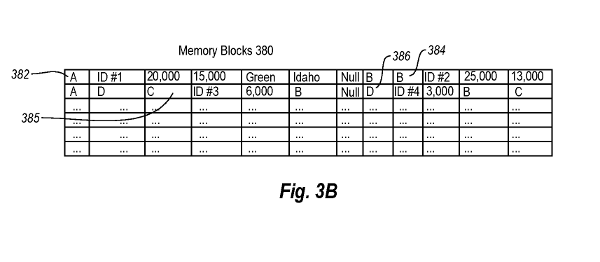

For example, FIG. 3A depicts an implementation of an ordered flat file 106 stored in a highly efficient manner. Query 103 is received by query processor 105, which searches the ordered flat file 106 for the requested information. In the depicted implementation, the ordered flat file comprises a variety of different fields. For example, field 300 comprises memory locations of individual nodes, field 310 comprises employee IDs, field 320 comprises quarterly sales amounts, field 330 comprises previous quarter sales amounts, field 340 comprises a preferred product, field 350 comprises a sales area, FIG. 360 comprises pointers to respective parent nodes in an ordered flat file 106, and field 370 comprises pointers to respective children nodes in an ordered flat file 106.

In the depicted ordered flat file 106 several of the data fields do not comprise any information. For example, the entry associated with memory location “B” does not contain any data within fields 340 or 350. Similarly, the entries associated with memory locations “C” and “D” do not contain data within fields 330, 340, or 350. In at least one implementation, the above referenced fields may contain data, but the data may comprise a zero, a null, or some other default value. As such, these fields consume memory space with either no information or with highly repetitive information.

FIG. 3B depicts an implementation of the present invention on a memory block level. In the depicted memory blocks 380, the various entries are listed in a sequential order. In practice, however, one will understand that the various entries may be spread throughout various memory blocks 380 in a sequential order but linked for memory access purposes.

As depicted in FIG. 3B, each of the memory blocks 380 only comprises data fields that include one or more values, as shown in FIG. 3A. For example, entry “A” begins in memory block 382 and extends to entry “B” which begins in memory block 384. Each of the data fields associated with entry “A” in FIG. 3A are present within the memory blocks 380 extending from memory block 382 to memory block 384. In contrast, the memory blocks 380 associated with entry “B” only contain information associated with data fields 320, 330, 360, and 370. As such, the depicted memory blocks 380 do not contain information related to data fields 340 and 350 for entry B, which as shown in FIG. 3A are empty. Similarly, as depicted in FIG. 3B memory blocks associated with entries C and D do not contain data from fields 330, 340, or 350.

Accordingly, implementations of the present invention such as depicted in FIG. 3B can save significant memory space by only saving data fields that comprise data that is not highly inferable. For example, in at least one implementation, the data fields that are excluded from the memory blocks 380 do contain values of interest, but the particular values are highly repetitive within the particular data field within the ordered flat file 106. In this case, the particular values are noted by the query processor 105, such that when the specific data field is not present within the memory blocks 380, the query processor 105 infers that the value is equal to the previously identified particular value.

Returning to FIG. 3A, query 103 is directed towards returning from entry C a preferred product. Entry C, however, does not contain any data within field 340 that is associated with a preferred product. Accordingly, when the query processor 105 accesses the memory blocks 380 that are associated with entry C it will identify that a memory block associated with field 340 is not saved within memory. This determination may be made my associating a particular field identifier with each stored block within the memory blocks 380. As such, the query processor 105 can determine that within the memory blocks 380 entry C is stored with fields 310, 320, 360, and 370. The query processor 105 can then determine that memory blocks 330, 340, and 350 are the default value because they were not saved within the memory blocks 380.

Once this determination has been made, the query processor 105 can access a list of default values for each field. For example, the default value for field 340 may be null, or some default product (e.g., orange). Accordingly, the query processor 105 can return a pre-determined value based upon the identification of a missing data field.

Similarly, in at least one implementation, a default value can be returned for a field that does contain an actual value. For example, a rank field may contain the number “1.” In at least one implementation, upon identifying the rank file #1, the query processor 105 can access a list of default values and determine that the displayed information for a rank field with a value of #1 should be a “Gold Star.”

Additionally, in at least one implementation, a particular data field may be wholly comprised of calculated information. As such, it may not be necessary to store the actual calculated information within the memory blocks 380. For example, when the query processor 105 receives a query directed towards a calculated field, the query processor 105 can identify the field as being a calculated field and can directly calculate the proper field value. For example, instead of storing the calculated value, the field may store an indicator that the query processor 105 can use to determine the necessary calculation to perform. Along these lines, the memory blocks 380 may not store a data field for “life-time sales.” Instead, this value may be calculated on demand. Accordingly, in at least one implementation, it may not be necessary to constantly update calculated value until they are accessed and it may not be necessary to store calculated values within the memory blocks 380.

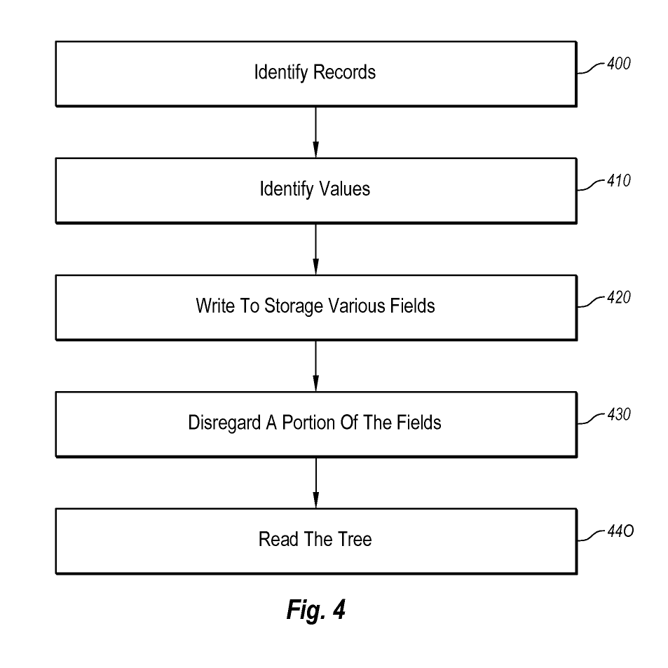

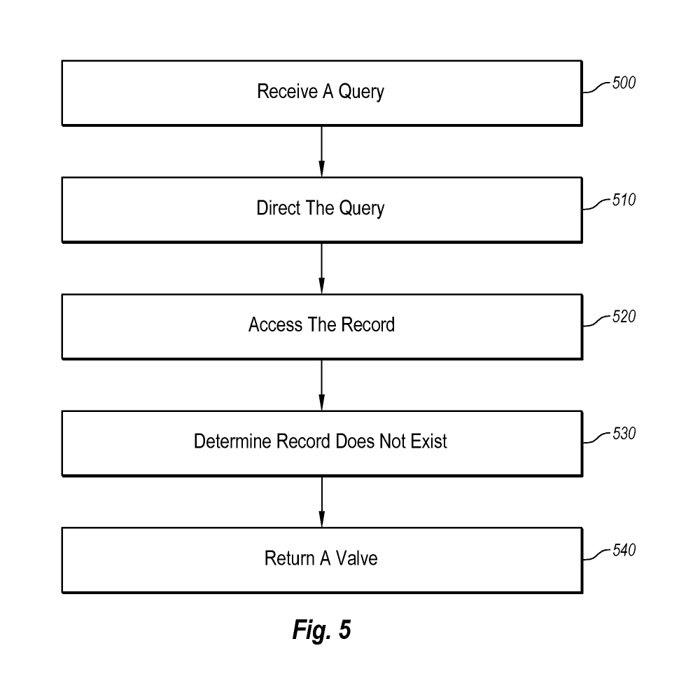

Accordingly, FIGS. 1-3B and the corresponding text illustrate or otherwise describe one or more methods, systems, and/or instructions stored on a storage medium for efficiently storing an ordered flat file within memory. One will appreciate that implementations of the present invention can also be described in terms of methods comprising one or more acts for accomplishing a particular result. For example, FIGS. 4 and 5 and the corresponding text illustrate flowcharts of a sequence of acts in a method for efficiently storing an ordered flat file within memory. The acts of FIGS. 4 and 5 are described below with reference to the components and modules illustrated in FIGS. 1-3B.

For example, FIG. 4 illustrates that a flow chart for an implementation of a method for efficiently storing an ordered flat file within memory can comprise an act 400 of identifying records. Act 400 includes identifying a particular number of records within a hierarchical tree, wherein each record within the hierarchical tree comprises a specific number of fields. For example, in FIG. 1 and the accompanying description, the flat file generator 106 identifies the records within the hierarchical tree.

FIG. 4 also shows that the method can comprise an act 410 of identifying values. Act 410 includes identifying a particular value within fields of the hierarchical tree that appears within a plurality of the fields of the hierarchical tree. For example, in FIG. 3 and the accompanying description, field 330 for both entries C and D comprise the same value (e.g., null or zero).

Additionally, FIG. 4 shows that the method can include an act 420 of writing various fields to storage. Act 420 includes writing to storage at least a portion of the fields of the hierarchical tree in a flat file order that is directly related to the order of records in the hierarchical tree. For example, FIG. 3C depicts the various fields of the ordered flat file 106 written to memory blocks 380.

FIG. 4 also shows that the method can include an act 430 of disregarding a portion of the fields. Act 430 includes disregarding a plurality of fields that contains the particular value so that the disregarded plurality of fields do not exist in storage. For example, in FIG. 3B and the accompanying description, data fields 340 and 350 of entries B, C, and D are disregarded when writing to the memory blocks 380.

Further, FIG. 4 shows that the method can include an act 440 of reading the tree. Act 440 includes reading the tree so that when encountering a field that is not found in storage, the field is designated for that record as containing the particular value. For example, as depicted in FIG. 3A, query 103 is directed towards a field that is not contained within memory (i.e., field 340 for entry C). Upon receiving a request for that field, the query processor 105 can return a predetermined default value for that specific field.

As an example of an additional or alternative implementation, FIG. 5 illustrates that a flow chart for an implementation of a method for efficiently storing data entries within a database can comprise an act 500 of receiving a query 500. Act 500 includes receiving an inquiry directed towards a particular field within a record associated with an entry of a hierarchical tree. For example, FIG. 3A depicts a query 103 being received.

FIG. 5 also shows that the method can comprise an act 510 of directing a query. Act 510 includes directing the inquiry to a flat file that represents the hierarchical tree. For example, in FIG. 3A and the accompanying description, query 103 is directed to an ordered flat file 106 that represents hierarchically organized data 210.

Additionally, FIG. 5 shows that the method can comprise an act 520 of accessing the record. Act 520 can include accessing the record within the flat file. For example, FIG. 3A and the accompanying descriptions describe the query processor 105 accessing a record within the ordered flat file 106.

FIG. 5 also shows that the method can comprise act 530 of determining that the record does not exist. Act 530 includes determining that the requested field does not exist within the record. For example, in FIG. 3A and the accompanying description, the query processor 105 determines that data field 340 associated with entry does not exist within the memory blocks 380.

Further, FIG. 5 shows that the method comprises act 540 of returning a value. Act 540 includes upon identifying that the requested field does not exist, returning a value that indicates an actual value for the field. For example, FIGS. 3A-3B depict a default value being returned by the query processor 105 for fields that are not present within the memory blocks 380.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

Embodiments of the present invention may comprise or utilize a special-purpose or general-purpose computer system that includes computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud computing model can be composed of various characteristics, such as on-demand self-service, broad network access, resource pooling, rapid elasticity, measured service, and so forth. A cloud computing model may also come in the form of various service models such as, for example, Software as a Service (“SaaS”), Platform as a Service (“PaaS”), and Infrastructure as a Service (“IaaS”). The cloud computing model may also be deployed using different deployment models such as private cloud, community cloud, public cloud, hybrid cloud, and so forth.

Some embodiments, such as a cloud computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. At a server computer system that receives queries from one or more client computers for calculating downline information relative to a hierarchically organized data structure, a computerized method for efficiently storing data entries within a database, the method comprising:
identifying a particular number of records within a hierarchical tree, wherein each record within the hierarchical tree comprises a specific number of fields;
identifying a particular characteristic within one or more fields of the hierarchical tree;
writing to storage at least a portion of the fields of the hierarchical tree in a flat file order that is directly related to the order of records in the hierarchical tree, wherein writing to storage at least a portion of the fields of the hierarchical tree, comprises:
disregarding the one or more fields that contains the particular characteristic so that the disregarded one or more fields do not exist in storage; and
reading the tree so that when encountering a field not found in storage the field is designated for that record as containing the particular value.

2. The method as recited in claim 1, wherein the flat file order comprises information stored within the hierarchical tree, including information associating each data entry within the first hierarchical tree with the data entry's relative position within the first hierarchical tree.

3. The method as recited in claim 1, wherein the particular characteristic is a value of zero.

4. The method as recited in claim 1, further comprising:
identifying the most common value that appears within the fields of the hierarchical tree; and
designating the identified most common value as the particular value.

5. The method as recited in claim 1, further comprising:
receiving a direction to add a new record to the hierarchical tree, wherein the logical position of the new record within the flat file order is other than at the end of the flat file order; and
identifying a parent record of the new record within the hierarchical tree;
writing the new record to storage, wherein the new record is located outside of the flat file order; and
associating a first pointer with the parent record such that the parent record comprises a first pointer that points to the new record.

6. The method as recited in claim 5, further comprising:
identifying within the parent record a second pointer that points to a child of the parent record, wherein the child is different than the new record; and
associating the second pointer with the new record such that new record comprises a second pointer that points to the child of the parent record.

7. The method as recited in claim 5, further comprising:
receiving a command to rebuild the flat file order of the hierarchical tree;
rewriting to storage at least a portion of the fields of the hierarchical tree in a flat file order that is directly related to the order of records in the hierarchical tree, wherein the at least a portion of the fields of the hierarchical tree includes the new record.

8. The method as recited in claim 5, wherein pointers point to a byte location within storage.

9. At a server computer system that receives queries from one or more client computers for calculating downline information relative to a hierarchically organized data structure, a computerized method for efficiently storing data entries within a database, the method comprising:
receiving an inquiry directed towards a particular field within a record associated with a node of a hierarchical tree;
directing the inquiry to a flat file that represents the hierarchical tree;
accessing the record within the flat file;
determining that the requested field does not exist within the record; and
upon identifying that the requested field does not exist, returning a particular value that indicates an actual value for the field.

10. The method as recited in claim 9, wherein the flat file comprises information stored within the hierarchical tree, including information associating each data entry within the first hierarchical tree with the data entry's relative position within the first hierarchical tree.

11. The method as recited in claim 9, wherein the particular value is calculated using values stored within other fields.

12. The method as recited in claim 9, further comprising:
identifying a common value that appears multiple times within the fields of the hierarchical tree; and
designating the common value as the particular value.

13. At a server computer system that receives queries from one or more client computers for calculating downline information relative to a hierarchically organized data structure, a computerized method for efficiently storing data entries within a database, the method comprising:
identifying a particular number of records within a hierarchical tree, wherein each record within the hierarchical tree comprises a specific number of fields;
identifying a particular characteristic within one or more fields of the hierarchical tree;
writing to storage at least a portion of the fields of the hierarchical tree in a flat file order that is directly related to the order of records in the hierarchical tree, wherein writing to storage at least a portion of the fields of the hierarchical tree, comprises:
disregarding the one or more fields that contains the particular characteristic so that the disregarded one or more fields do not exist in storage; and
reading the tree so that when encountering a field not found in storage the field is designated for that record as containing the particular value.

14. The method as recited in claim 13, wherein the flat file order comprises information stored within the hierarchical tree, including information associating each data entry within the first hierarchical tree with the data entry's relative position within the first hierarchical tree.

15. The method as recited in claim 13, wherein the particular value is calculated using values stored within other fields.
